(19) United States
(12) Patent Application Publication
(10) Pub. No.: US 2002/0162466 A1
(43) Pub. Date: Nov. 7, 2002

(54) Inking unit in a printing press

(76) Inventor: Wolfgang Schonberger, Schriesheim (DE)

Correspondence Address: LERNER AND GREENBERG, P.A., Post Office Box 2480, Hollywood, FL, 33022-2480, US

(21) Appl. No.: 10/033,127

(22) Filed: Oct. 22, 2001

(30) Foreign Application Priority Data
Oct. 20, 2000 (DE) 100 52 011.1

(51) Int. Cl. B41F 31/00

(52) U.S. Cl. 101/350.3

(57) ABSTRACT

An inking unit in a printing press includes an ink-metering device having at least one metering element operatively engaging with a roller, the roller being one of an ink form roller and a roller operatively engaging with an ink form roller, and an oscillation device assigned to the metering element for mounting the metering element so that it is oscillatable between a feeding position and a spaced-away position of the metering element.

### BACKGROUND OF THE INVENTION

1. Field of the Invention

The invention refers to an inking unit in a printing press, which includes an ink-metering device having at least one metering element operatively engaging with a roller, the roller being one of an ink form roller and a roller operatively engaging with an ink form roller.

In the German Published Prosecuted Patent Application (DE-AS) 2323025, such an inking unit is described having a metering element formed as a scraping blade and engaging with a metering roller, which, in turn, is in operative engagement with an ink form roller, so that the inking unit is comparatively short. An unfavorable feature of this inking unit is that dirt particles which have been accumulated and collected between the metering roller and the scraping blade can lead to blockages and, consequently, to a formation of striations in the ink film on the metering roller.

In the published German Patent Document DE 3714936 C2, another inking unit is described corresponding to the type mentioned in the introduction hereto, this inking unit having a metering element formed as a metering bar engaging with an ink form roller, so that the inking-unit is extremely short. With this inking unit, the blockages caused by dirt-particles are supposed to be avoided by arranging the metering bar so that it oscillates around an axis. In one of the embodiments illustrated in this published German patent document, the axis lies in the center of the form roller, and in another of the embodiments thereof, it lies in the center of a curvature of a scraping edge of the metering bar, so that the latter cannot be removed from the form roller in any of the embodiments, because of the oscillation thereof. The thickness of an ink film metered by a metering bar on the form roller can be set or adjusted by contact pressure of greater or lesser strength being applied by the metering bar against the form roller. What is unfavorable about this inking unit is that, because of the stationary axis of the metering bar, dirt particles clinging very stubbornly to the metering bar are unable to be removed. Furthermore, it is disadvantageous that, for adjusting the thickness of the ink film, especially to a relatively slight thickness, a strong contact pressure of the metering bar against the form roller is necessary, and that the metering bar wears very quickly due to the strong contact pressure. Even if a protective coating that is stretched over the metering bar is proposed, which can be exchanged for a new protective coating when it has become worn, the proposed technical improvement is unsatisfactory, because the exchange of the protective coating each time requires a longer downtime for the printing press.

In the published German Prosecuted Application (DE-AS) 2530109, an inking-unit is described that does not correspond to the type mentioned at the introduction hereto, but rather constitutes a more remote state of the art, which has a metering element formed as an ink knife subdivided into ink-knife zones which are lifted away from an ink duct roller, in accordance with numbers of pulses. What is disadvantageous regarding this inking unit is the long structure thereof resulting from many rollers, namely the ink duct roller, an ink transfer roller and further inking unit rollers, which not only requires a considerable amount of construction space, but which also reduces the rapidity of the response time of the inking unit for metering-quantity adjustments.

In U.S. Pat. No. 5,226,364, an inking unit is described that also represents only a remote state of the art, the inking unit including a metering blade engaging a metering roller, the metering blade being set into ultrasonic oscillations. The metering blade being a component of a chambered doctor blade, in the chamber of which the printing ink is maintained under excess pressure, which holds the metering blade on the metering roller.

### SUMMARY OF THE INVENTION

It is accordingly an object of the invention to provide an inking unit in a printing press, the inking unit being short or extremely short and serving for excluding blockages in the region of the metering element and minimizing wear of the metering element.

With the foregoing and other objects in view, there is provided, in accordance with one aspect of the invention, an inking unit in a printing press, comprising an ink-metering device having at least one metering element operatively engaging with a roller, said roller being one of an ink form roller and a roller operatively engaging with an ink form roller, and an oscillation device assigned to said metering element for mounting said metering element so that it is oscillatable between a feeding position and a spaced-away position of the metering element.

In accordance with another feature of the invention, the oscillation device has a guide for guiding the metering element in an at least approximately radial oscillation direction relative to the roller.

In accordance with a further feature of the invention, the oscillation device has an electromagnetic oscillation drive drivingly connected to the metering element.

In accordance with an added feature of the invention, the oscillation device has a spring for setting the metering element against the roller.

In accordance with an additional feature of the invention, the metering element is a metering blade having a working region terminating in a cutting edge, the working region of the metering blade having a cross-section thickness which remains constant.

In accordance with yet another feature of the invention, the inking unit includes at least one glazed roller disposed downline from the metering element along a peripheral line of the first-mentioned roller, the glazed roller being exclusively in rolling contact with the first-mentioned roller.

In accordance with yet a further feature of the invention, the inking unit includes an ink-feeding device disposed upline of the metering element alongside a peripheral line of the first-mentioned roller.

In accordance with yet an added feature of the invention, the inking unit includes at least another metering element assigned to the first-mentioned roller.

In accordance with yet an additional feature of the invention, the metering elements are mounted alternatingly with one another for removal thereof from the first-mentioned roller.

In accordance with another aspect of the invention, there is provided a printing press having an inking unit comprising an ink-metering device having at least one metering element operatively engaging with a roller, the roller being one of an ink form roller and a roller operatively engaging with an ink form roller, and an oscillation device assigned to the metering element for mounting the metering element so that it is oscillatable between a feeding position and a spaced-away position of the metering element.

Thus, the inking unit in a printing press according to the invention, having an ink-metering device with at least one metering element, which engages in a feeding position with the roller, the latter being either a form roller or being a roller disposed so that the metering element is oscillatable between a feeding position and a spaced-away position by an oscillation device assigned to the metering element.

An advantage of the inking unit according to the invention is that there is a gap every time between the metering element and the outer cylindrical surface of the roller, when the metering element reaches the spaced-away position in the course of the oscillation imposed by the oscillation device. When measured, the gap is larger than the dirt particles found in the printing ink, so that the dirt particles can pass through the gap without getting stuck. The discontinuous engagement of the metering element during the metering operation at the roller is furthermore desirable with respect to a prolonged service life of the metering element.

In an advantageous development because of the dynamic pressure of the printing ink, with regard to largely unaffected oscillation of the metering element, a lead is assigned thereto as a component of the oscillation device, which prescribes for the oscillation the approximate radial oscillation direction thereof, relative to the roller. The dynamic pressure of the printing ink is effective, therefore, at least approximately perpendicularly to the oscillation direction of the metering element and practically has no force component whatsoever, which has an effect upon the metering element in the oscillation direction. The oscillating movement thereof is therefore unaffected by the dynamic pressure which, in turn, depends upon the machine speed, i.e., the speed of the outer cylindrical surface of the roller, and upon the viscosity of the printing ink. For example, with the radial oscillation direction excluded, the dynamic pressure, which rises as a consequence of the increase of the machine speed, a reinforced absorption or damping of the oscillation movement is effected.

With a development regarding a frequency and/or amplitude-controlled ink-density modification, an electromagnetic oscillation drive is assigned to the metering element, which is at the same time also a component of the oscillation device. Through a corresponding activation of the oscillation drive, the frequency of the oscillation of the metering element, the period or frequency number of the oscillation, respectively, per one revolution of the roller and thereby the number and distance to one another, of ink lines that have been formed on the roller, can be modified.

The amplitude of the oscillation of the metering element that corresponds to the spaced-away position is modifiable, so that the printing ink that has been metered with the metering element can form low elevations with small amplitude and high elevations with big amplitude, like for example ink lines on the outer cylindrical surface of the roller. What is also an advantage of the control of the amount of metering, which ensues via the frequency and/or amplitude, is that the contact-pressure of the metering element against the roller can be chosen independently from the set amount of metering. To reduce the film-layer thickness of the ink lines, which is produced with the metering element on the roller, an increase of the contact-pressure of the metering element in the feeding position on the roller is unnecessary. In other words, because there is a reduction in the metering-amount does not mean that there is an increase in the abrasion of the roller and metering element that is dependent upon the contact-pressure. With each set metering amount, the contact-pressure can be the same and comparatively low.

Furthermore, instead of the electromagnetic oscillation drive, an hydraulic or pneumatic or piezoelectric oscillation drive can be provided.

With an advantageous development regarding the compensation for a shortening of the metering element, which is caused by wear, a spring which is at the same time also a component of the oscillation-device is assigned to the metering element. The spring pushes or pulls the metering element out of the spaced-away position back into the feeding position. Even though the tension of the spring is greatest with the metering element located in the spaced-away position, the spring is yet also in bias with the metering element, when the latter is located in the feeding position. The modification of the covered spring-path of the spring between the spaced-away position and the feeding position, resulting from the shortening of the metering element due to wear, is so small that the modification practically has no effect whatsoever on the size of the contact-pressure of the metering element against the roller. In other words, the spring still forces the metering element against the roller with the same force, in a more worn and shortened condition, as in the less worn condition of the metering element. The characteristic line of the spring is chosen so that the corresponding modification of the spring path in the shortening of the metering element cannot have an undesirable effect. The assignment of the spring to the metering element makes the automatic adjustment with the wear of the metering element possible, and also with the preferred development wherein the metering element has an at least approximate radial oscillation direction relative to the roller. The spring adjusts the wearing metering element in precisely this at least approximate radial oscillation direction. A sprung formation of the metering element, for example, in the form of a flexible spring-steel blade or knife, is still possible yet with the existence of the spring that is assigned to the metering element, however, the spring makes a non-flexible, rigid formation of the metering element in a multiplicity of geometric forms possible, like for example as a rigid metering bar, as a rigid metering eccentric or as a rigid metering slider.

With an advantageous development regarding a non-varying geometry of a scraping or stripping edge or a blade of the metering element resulting from the wear of the metering element, the latter has a work region which terminates in a blade, of which the lamellar or cross-sectional thickness remains constant. The cross-sectional thickness is measured perpendicularly to the adjusting-direction of the metering element, which corresponds to the oscillation direction, and perpendicularly to a rotational axis of the roller. Along the adjusting-direction, the cross-sectional thickness does not change within the work region. With the formation of the metering element as a metering blade, the cross-sectional width corresponds to the blade-thickness of the metering blade. In contrast with a metering blade that runs sharply towards the cutting edge, the shortening due to wear, when using the metering element according to the invention, does not have the effect of a widening of the blade, which would otherwise reduce the metering-accuracy.

With an advantageous development regarding a flat-rolling of the produced ink elevations on the outer cylindrical or circular surface of the roller by at least one metering element, to a closed-coating of an ink film with constant film-layer thickness, at least one calender or glazing roller is set in rolling contact with the roller, the glazing roller being located downline from the metering element, as viewed in the direction of rotation of the roller. The glazing roller engages only with that roller to which the metering element is assigned. The glazing roller has no rolling contact with any other roller.

For multistage smoothing of the ink lines or small mounds of ink and the ink film resulting therefrom, preferably a multiplicity of such glazing rollers are assigned consecutively to the first-mentioned roller.

With an advantageous development regarding the full-surface application of the printing ink to the roller preceding or upline from the metering element, as viewed in the direction of rotation of the roller, an ink-feeding device in the form of a feed roller is assigned to the metering element. By the ink-feeding device, the printing ink, which can also be a varnish, is placed on the roller and forms thereon afterwards a comparatively thick ink film with a closed film surface. Due to the action of the oscillating metering element on the applied ink film, the thickness thereof is reduced to a required measure, and the film surface becomes structured. Due to the structuring of the ink film, the latter is reduced in thickness or interrupted periodically. The ink-pattern produced as a consequence of the structuring on the roller is made up of evenly distributed ink lines or small mounds of ink which, in the case of the interrupted ink film, lie on the surface of the roller, completely separated from one another or, in the case of the reduced ink-film thickness, can form an ink-profile with a closed ink-layer.

With an advantageous development regarding the production of an ink pattern, which is formed of a multiplicity of extended rows of small mounds of ink lying adjacent one another and in the circular or outer cylindrical direction of the roller, a multiplicity of metering elements are assigned to the roller, the metering elements being formed and arranged in accordance with the aforedescribed metering element. The metering elements are arranged close to one another in an extended row, parallel to the axis of the roller and extending over the area being inked, the inking elements together forming a metering device.

The metering elements are disposed so as to be removable from the roller, independently of one another and in exchange with one another, in regard to the production of an ink pattern on the roller, the ink pattern being formed of a multiplicity of extended rows of small mounds of ink, which lie adjacent one another and extending in a direction parallel to the axis.

For example, with the aforementioned metering device, the metering elements seated within the row of even-numbered positions can form prongs of a first metering comb, and the metering elements which are seated within the row of uneven-numbered positions can form prongs of a second metering comb. The metering combs perform oscillations which are phase-shifted from one another between the feeding position and the spaced-apart position, so that the metering elements which are seated on the even-numbered positions are always set against the roller in exchange with the metering elements which are seated on the uneven-numbered positions.

Preferably, the inking-unit is formed as a so-called zone-less inking unit for the even metering of the printing ink over the print-width. The aforementioned formation of metering elements of the metering-device does not contradict the foregoing in any way, because an ink-zone profile is not actually created. An ink-zone profile is characterized by an uneven course over the print-width. With heretofore known ink-zone adjustment devices for the production of such an ink-zone profile, each of the metering elements is controlled individually to which the extent of coverage and the ink demand of a printing form in the ink zone are assigned. In crass contrast thereto by a metering device including metering elements of the zone-less inking unit within the framework of the invention, an even ink pattern is produced on the roller over the print width. This ink pattern can extend over the print width as one of the ink lines without interruption, as has been repeatedly mentioned hereinbefore. The height of the ink line, i.e., the layer thickness, is constant over the whole print width. The ink pattern can also include small piles of ink, which also have been mentioned hereinbefore, and which are applied to the roller in an extending row and spaced from one another over the whole print width. The row formed of small mounds of ink can also be looked at as an ink line that has been interrupted at regular intervals. All small mounds of ink have the same height, i.e., layer thickness. And also other even ink patterns, i.e., ink-patterns which repeat themselves regularly with the metering device on the roller over the print width, do not in any way contradict a zone-less formation of the inking unit.

Other features which are considered as characteristic for the invention are set forth in the appended claims.

Although the invention is illustrated and described herein as embodied in an inking unit in a printing press, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings, wherein:

### BRIEF DESCRIPTION OF THE DRAWINGS

FIG. 1 is a diagrammatic side elevational view of a printing press with an ultra-short inking unit having an ink-metering device;

FIG. 2 is an enlarged fragmentary view of FIG. 1;

FIG. 3a is an enlarged longitudinal sectional view of an oscillating device of the ink-metering device;

FIG. 3b is a view similar to that of FIG. 3a showing the oscillating device with a worn metering element;

FIG. 4 is a side elevational view of the oscillating device of FIG. 3a;

FIGS. 5a to 5c are diagrammatic side elevational views of FIG. 3a showing the oscillating device in different oscillating phases;

FIG. 6 is an ink pattern produced with the ink-metering device during the different oscillating phases;

FIG. 7 is a diagrammatic view, partly in section, of an alternative construction of the ink-metering device; and

FIG. 8 is a view similar to that of FIG. 1 of a different embodiment of the inking unit, which has a modified and somewhat longer construction than that of FIG. 1.

### DESCRIPTION OF THE PREFERRED EMBODIMENTS

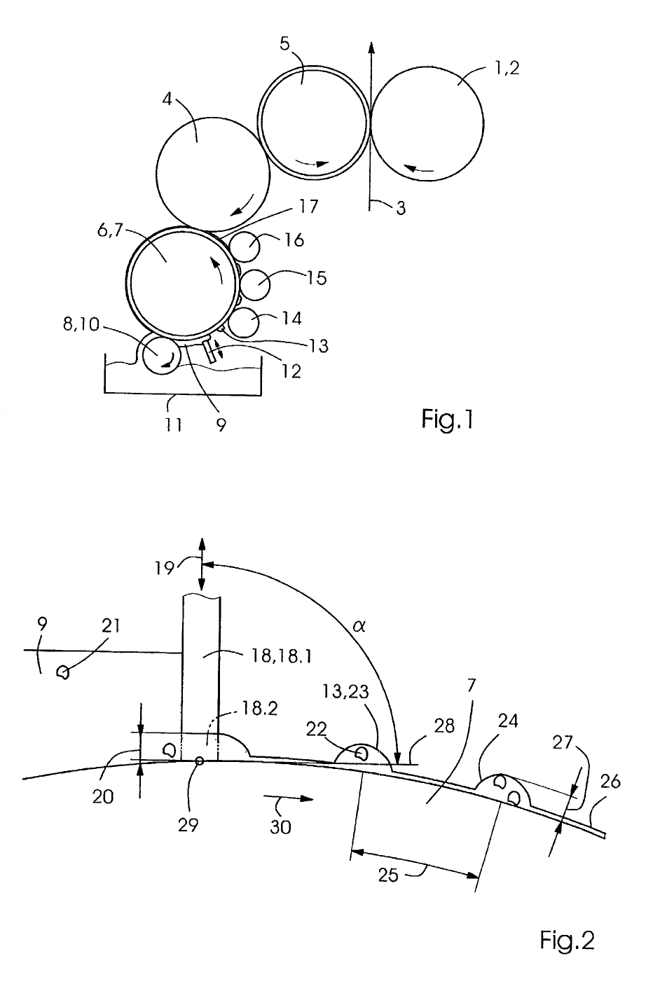

Referring now to the drawings and, first, particularly to FIG. 1 thereof, there is shown therein a printing press 1, more specifically, a sheet-fed rotary offset printing press, with an impression cylinder 2 for carrying a printing carrier or stock 3, a printing form cylinder 4, a blanket cylinder 5 for transferring a printing image from the printing form cylinder 4 onto the printing carrier 3, and an inking unit 6 for inking the printing form cylinder 4.

The inking unit 6 includes a roller 7, which rolls in angular synchronism, as an ink form roller or plate inking roller, on the printing form cylinder 4 and has a rubber-elastic and elastomeric peripheral surface, respectively, which is smooth. The diameters of the roller 7 and of the printing form cylinder 4 are of like size.

An ink-feeding device 8 is assigned to the roller 7 and applies a full-surface, i.e. irregular or plain ink film 9 to the roller 7, the ink-feeding device 8 including a roller 10 synchronously rolling on the roller 7, and an ink trough 11, wherein the roller 10 is disposed as a dip roller.

An ink-metering device 12 for converting the ink film 9 into a uniform ink or color specimen 13 is arranged downline from the ink-feeding device 8 and upline from the printing form cylinder 4, as viewed in the direction of rotation of the roller 7.

Glazing rollers 14, 15, 16 are disposed downline from the ink-metering device 12, and roll exclusively on the roller 7. The glazing rollers roll the ink specimen 13 flat into a full-surface, i.e. plain, ink film with a layer-thickness of 10 to 15 μm, which is considerably less than the layer-thickness of the ink film 9. The ink film 17 is split between the roller 7 and the printing form cylinder 4 and is thereby partially transferred onto the printing form cylinder 4.

In FIG. 2, a metering element of the ink-metering device 12, which serves as a metering blade 18, is shown in a spaced-away position 18.1 and in a feeding position 18.2 relative to the roller 7. During metering, the metering element 18 oscillates between the spaced-away position 18.1 and the feeding position 18.2 in a linear oscillating direction 19, with a frequency that is adjustable within a range of 200 Hz to 10 kHz. In this regard, the metering blade 18 is periodically lifted an outlet height 20 from the roller 7, the outlet height being preferably within a range of 20 to 40 μm and, in any case, less than 100 μm. The spaced-away position 18.1 wherein the metering blade 18 reaches the outlet height 20, and the feeding position 18.2 are reversal points of the oscillation of the metering blade 18. The outlet height 20 is much larger than the largest dimension of dirt particles 21, 22 found in a printing ink that forms the ink film 9, so that the dirt particles 21, 22 can pass through a metering gap determined by the outlet height 20 and located between the metering blade 18 and the outer cylindrical surface of the roller 7, without getting stuck in the metering gap.

Furthermore, it is believed to be apparent from FIG. 2 that the ink pattern 13 is made up of ink elevations 23, 24, which extend as ink lines axially parallel to the roller 7 on the outer cylindrical surface of the roller 7 and that are offset an arc length 25 from one another.

The arc length 25 of like size located between all of the adjacent ink elevations 23, 24 on the roller 7 is proportional to the frequency of the oscillation of the metering blade 18 and may be within the range of 1 mm to 20 mm.

The outer cylindrical surface of the roller 7 may have a microstructure, e.g. a surface-roughness, formed by sandblasting, or a cell-grid produced by engraving, which allows a very thin lubricating film 26 to pass through between the roller 7 and the metering blade 18. The lubricating film 26 prevents premature abrasive wear of the metering blade 18 and is quantitatively smaller than that ink quantity which is required for printing the lowest desired ink density, e.g. a full-tone density of 0.5.

The layer-thickness of the ink film 17 can be varied by effecting an adjustment of the oscillation frequency of the metering blade 18 and/or by adjusting the spaced-away position 18.1 and, thereby, the outlet height 20. The arc length 25, i.e., the spaced-apart distance of the ink elevations 23, 24 from one another, is proportional to the frequency of the oscillation, which represents a first adjustment-parameter. The higher the frequency, the shorter the arc length 25 and the greater the layer-thickness of the ink film 17 are and, thereby, also the greater the ink-quantity that is transferred to the printing form cylinder 4.

Likewise, a proportionality exists between the outlet height 20 representing a second adjustment-parameter, and the layer-thickness of the ink film 17. The more the spaced-away position 18.1 has been adjusted away from the roller 7, the greater is an ink profile height 27 of the ink elevations 23, 24 and, thereby, of the layer-thickness of the ink film 17.

The oscillation-direction 19 and a tangential line 28 to the roller 7 intersect at a contact-point 29, at which the metering blade 18 is placed on the roller 7. An angle α with reference to the contact-point 29 as the vertex thereof, and subtended respectively by the oscillation-direction line 19 and the tangential line 28, may have a value of from 70° to 90°, so that the oscillating direction 19 either slightly counter-rotatingly aligned (α=90°) in radial direction of the roller 7 or (90°>α70°) with respect to a rotational direction 30 of the roller 7.

With an oscillating direction 19 that is slightly counter-rotatingly aligned, the metering blade 18 can also be described as a so-called negative doctor blade.

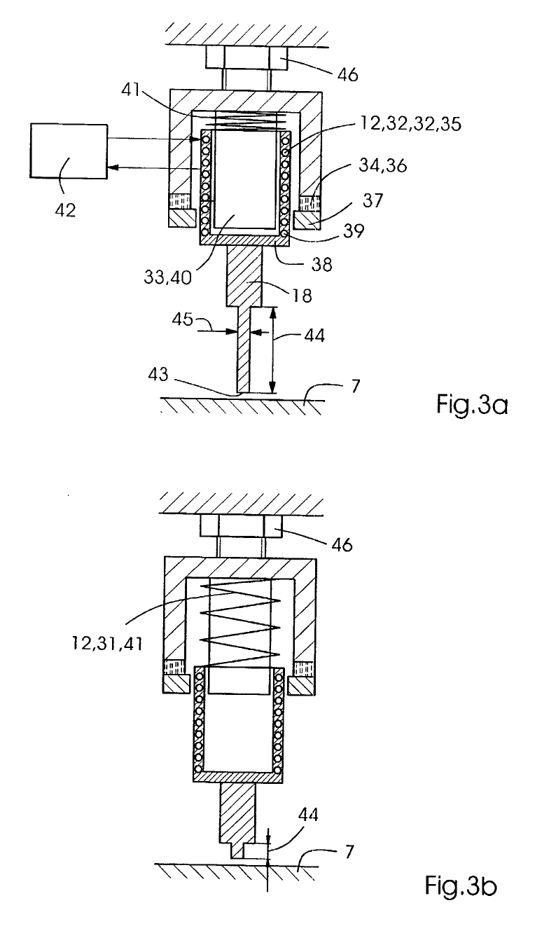

In FIGS. 3a and 3b, a possible first embodiment of an oscillating device 31 of the ink-metering-device 12 is illustrated. An oscillation drive 32 for exciting the oscillation of the metering blade 18 and a guide 33, which provides the metering blade 18 with the oscillating direction 19, belong to the oscillating device 31, which periodically swings the metering blade 18 out of the spaced-away position 18.1 into the feeding position 18.2 and back again.

The oscillation drive 32 is formed as an electric linear motor and includes a stator 34 and a rotor 35. The stator 34 is canister-shaped and includes a magnet 36, e.g., a permanent magnet, and a pole-plate 37 placed on the magnet 36. The rotor 35 is formed of a sleeve 38 whereon the metering blade 18 is fastened and which carries an electric coil 39 that is either molded into the sleeve 38 or wound thereon. The sleeve 38 is slidably attached to a guide pin 40 of the stator 34 for movement in the oscillating direction 19, so that the sleeve 38, together with the guide pin 40, forms the guide 33. A helical spring 41 biased by a compressive load between the stator 34 and the rotor 35 and being attached to the guide pin 40, is also a component of the oscillating device 31.

During the course of the oscillation of the metering blade 18, it is alternately adjusted by the oscillating drive 32 from the feeding position 18.2 thereof to the spaced-away position 18.1 thereof and restored by the spring 41 from the spaced-away position 18.1 to the feeding position 18.2. An electronic control device 42, with which the current cycle and, thereby, the frequency of the oscillation of the metering blade 18 is adjustable, decreases and increases the amperage of the electrical current flowing through the coil 39, and corresponding to the set frequency, so that the spring 41 forces the rotor 35 out of the stator 34 when the amperage is decreased, e.g., the current is turned off, and a magnetic force effective between the stator 34 and the rotor 35 retracts the rotor 35 into the stator 34, when the amperage is increased, e.g., the current is turned on.

It is conceivable to form the oscillation drive 32 as a controlled-away electrical linear drive. With such a construction, for each and every contact of the metering blade 18 with the roller 7, the then actual position of the metering element 18 can be found by a sensor or by analysis of the motor currents of the linear drive, and starting from the actual position, a compensation for the abrasion of the metering blade 18 and the non-circularities of the roller 7 can ensue, in that a new nominal position of the metering element 18 is prescribed which takes the wear and the non-circularities into account.

The metering element 18 has a work region 44 ending in a cutting edge 43 and has a cross-sectional thickness 45, which always remains constant with a decrease in length of the work region 44 due to wear, so that the cutting edge 43 is not widened and the metering accuracy is not affected by the wear of the metering element 18. With the construction of the metering element 18 as a so-called preground doctor blade, the terms tip thickness instead of cross-sectional thickness 45, and bevel or chamfer instead of cutting edge 43 are common used.

In FIG. 3a, the metering element 18 is illustrated in a less worn condition. In comparison therewith, FIG. 3b shows the metering element 18 in a more worn condition, wherein the work region 44 is shortened due to the abrasion thereof by the roller 7. In proportion with the greater or increased shortening of the metering element 18, the traversed spring path of the spring 41 increases between the positions 18.1 and 18.2, so that the shortening is compensated for. The increase in the spring path is so little and the spring characteristic line of the spring 41 is selected so that the contact-pressure of the metering element 18, which is effected by the spring 41, in the feeding position 18.2 against the roller 7 and the outlet height 20 in the spaced-away position 18.1, do not change to any noticeable extent so as to influence the metering accuracy, and are in fact preserved to a marked extent.

The coil 39, which serves as a moving coil is formed so that it always produces the same power-jolt and, thereby, always the same outlet height 20 for a like electrical pulse via the control device 42, independently of the assumed position thereof, in the feeding position 18.2, depending upon the shortening of the metering element 18 relative to the stator 34.

The spaced-away position 18.1 and, thereby, the outlet height 20 are precisely adjustable by an adjusting device 46, in that the oscillation device 31 is adjustable by the adjusting device 46 either towards or away from the roller 7. The adjusting device 46 is formed as a screw joint connecting the stator 34 with a frame of the printing press 1, due to the contortion of which the spacing of the oscillation device 31 is adjustable relative to the roller 7. What is essential is that the spring 41 loads the metering element 18 and pushes against the roller 7, respectively, when the metering element 18 is located in the feeding position 18.2. Not only does the spring 41 compensate for the shortening of the metering element 18, but also for occurring non-circularities of the roller 7. Additionally, variations in the diameter of the roller 7 caused by operational fluctuations of temperature are compensated for by the spring 41.

There are different possibilities for compensating for differences in diameter occurring over the axial length of the roller 7. A first possibility is advantageous, when the metering element 18 extends parallel to the axis of the roller 7 over the entire area thereof that requires inking, as the only metering element of the ink-metering device, e.g., in the form of a metering bar or a metering blade. In this case, the metering element can be formed ductile and flexible, so that the metering element 18 can cling over the length thereof on a casing or jacket line (generating) of the roller 7, which is not at all ideally straight because of the differences in diameter, and can follow that line. To adapt the metering element 18 to the contour of the roller 7, the spring 41 does not only have an effect upon the metering element 18, but also, distributed along the length of the metering element 18, more of such springs 41 are provided so as to act upon the metering element 18.

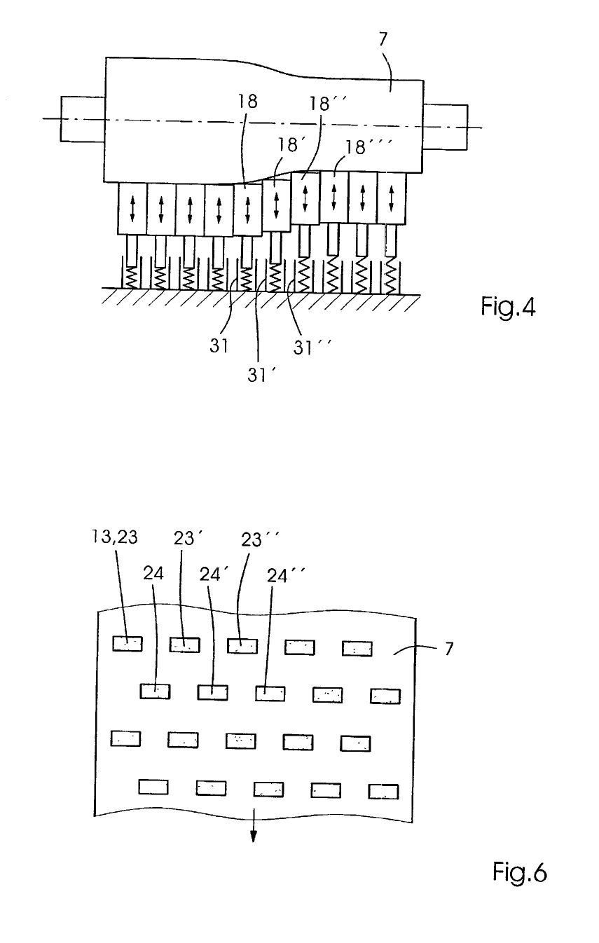

The second possibility requires that the ink-metering device 12 does not only include the metering element 18 and the oscillation device 31, but also others of such metering elements 18′, 18″, 18′″ and the oscillation devices 31′, 31″, respectively, which are assigned thereto, and shown in FIG. 4. In the interest of clarity, the diameter-differences are represented shown in a greatly exaggerated manner.

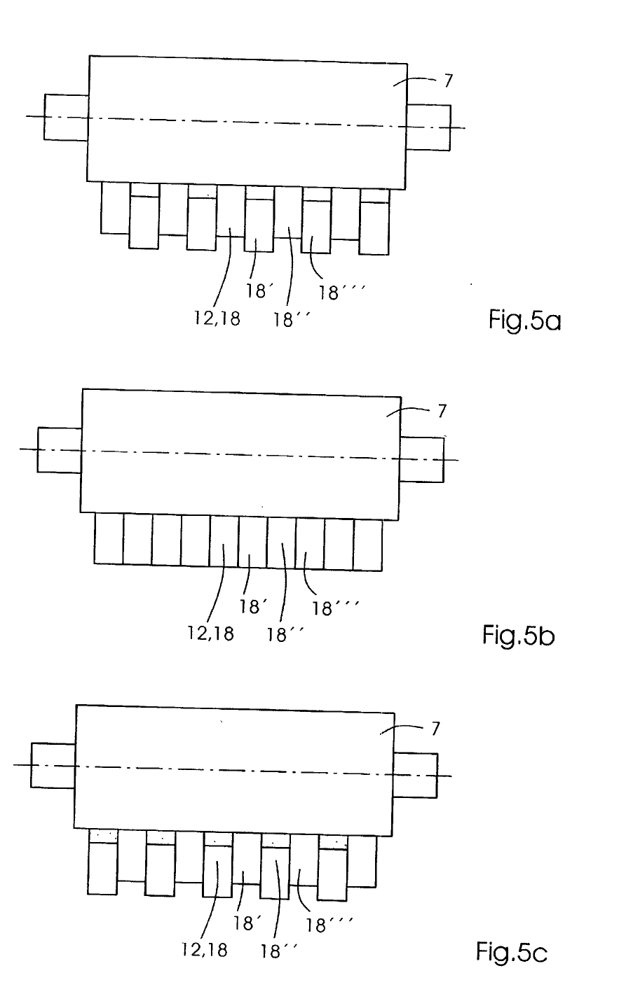

In accordance with successive continuous oscillation phases, FIGS. 5a through 5c illustrate the course of timely staggered movement of the metering elements 18, 18′, 18″, 18′″ of the segmented ink-metering-device 12 in FIG. 4.

In a first oscillation phase (note FIG. 5a) the metering elements 18′ and 18′″, i.e., the second and the fourth metering elements, and so forth, which are seated in a row on even-numbered location numbers, are open, and the metering elements 18 and 18″, i.e., the first and the third metering elements, and so forth, which are seated on uneven-numbered location numbers, are closed. During the first oscillation phase, an ink line is formed on the roller 7 from the ink elevation 23 and the other ink elevations 23′ and 23″.

In a second oscillation phase (note FIG. 5b) the metering elements 18, 18′, 18″ and 18′″, which are seated on the uneven-numbered as well as the even-numbered location numbers in the respective feeding position 18.2 thereof are located roller 7. The transition from the first to the second oscillation phase results from the oscillation of the metering elements 18′, 18′″, which are seated on the even-numbered location-numbers, into the closed position thereof.

In a third oscillation phase (note FIG. 5c) the metering elements 18, 18′, 18″ and 18′″ have an inverse oscillating position with respect to the first oscillation phase, the metering elements 18′ and 18′″, which are seated on the even-numbered location numbers, being located in the respective feeding position 18.2 thereof, and the metering elements 18 and 18″, which are seated on the uneven-numbered location numbers, being located in the respective spaced-away position 18.1 thereof, both positions being relative to the roller 7. The transition from the second to the third oscillation phase results from the oscillation of the metering elements 18 and 18″, which are seated on the uneven-numbered location numbers, into the opened position thereof. During the third oscillation phase, an ink line is formed on the roller 7, the ink elevations of which, namely ink elevations 24, 24′, 24″ are removed by gaps from the ink elevations 23, 23′, 23″ of the ink line formed in the first oscillation phase.

Via a fourth oscillation phase, wherein the ink-metering device 12 is briefly located in an oscillation position corresponding to the second oscillation position, the ink-metering device 12 arrives once more into the starting position of the oscillation, as shown in FIG. 5a, which continues in the described manner and repeats itself periodically.

If the time-interval of the second oscillation phase equals zero, i.e., if the metering elements 18 and 18″ are removing themselves from the roller 7 shortly before or at the instant of time the metering elements 18′ and 18′″ are being lowered onto the roller 7, a checkerboard-like ink-pattern without ink-free lines between the ink lines is produced which differs from the ink pattern 13 shown in FIG. 6 and resulting from the explained oscillation phases.

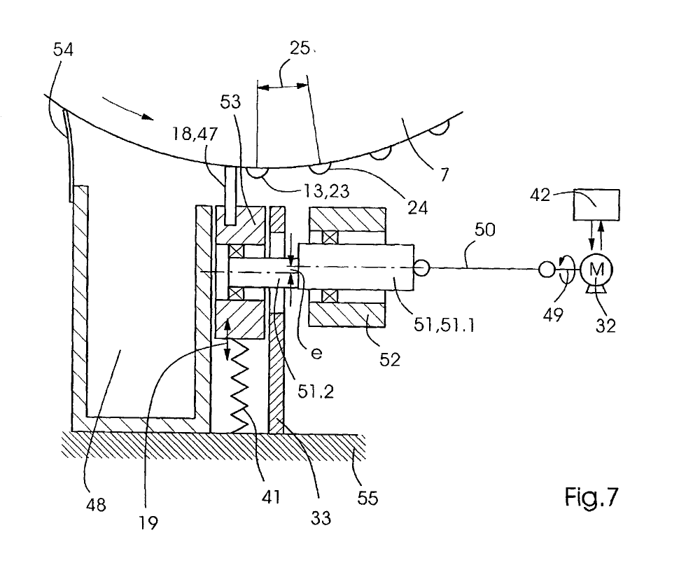

In FIG. 7, an ink-metering device 47, usable instead of the ink-metering device 12, together with an ink-feeding device 48, usable instead of the ink-feeding device 8, are shown. In the following description of the devices 47 and 48, for parts with the same functions, reference characters previously used herein in the description of the devices 8 and 12 have been adopted.

The oscillation drive 32 of the ink-metering device 47 is formed as an electric motor with a rotating motor-shaft 49. The shaft 49 is drivingly connected via a cardan or prop-shaft 50 with an eccentric pin 51, which is rotatably mounted by anti-friction bearings in a free oscillation element 52 via a ledge 51.1 thereof, and in a carrier 53 via a ledge 51.2 thereof having an eccentricity e to the ledge 51.1.

The carrier 53 is guided along the oscillating direction 19 by the guide 33 which, for the purpose of turning the ink-feeding device 48 on and off, is arranged on a frame 55 movably disposed on the roller 7, and on the ink-feeding device 48, respectively. The latter is formed as a chambered doctor blade, which includes the metering element 18 attached to the second carrier 53, the metering element 18 being a respective working and metering blade, and a negatively aligned locking blade 54, which is connected to a non-illustrated ink-feeding pump.

The spring 41 is biased between the carrier 53 and the frame 55 of the printing press 1, and presses the carrier 53 and the metering element 18 therewith against the roller 7. The arc-length 25 is adjustable through a modification of the rotational-speed of the oscillation drive 32, which is carried out at the control device 42. With a decrease in the rotational speed, the frequency of the oscillation of the metering element 18 is decreased, and with an increase in the rotational speed, the frequency is increased and thereby the metered ink-quantity is also increased. The ink-quantity can also be increased or decreased, however, by making amplitude adjustments of the oscillation. With the ink-metering device 47, for example, the eccentricity e and/or the bias or pretension of the spring 41 can be adjustable.

Furthermore, the control-device 42 can control the oscillation-drive 32 so that the oscillation drive 32 rotates alternatingly forwards and backwards using a given rotational angle. The size of the rotational angle is, in this case, in proportion to the amplitude, i.e., to the spaced-away position 18.1. In embodiment shown in FIG. 7, however, the oscillation drive rotates continuously in one and the same direction of rotation.

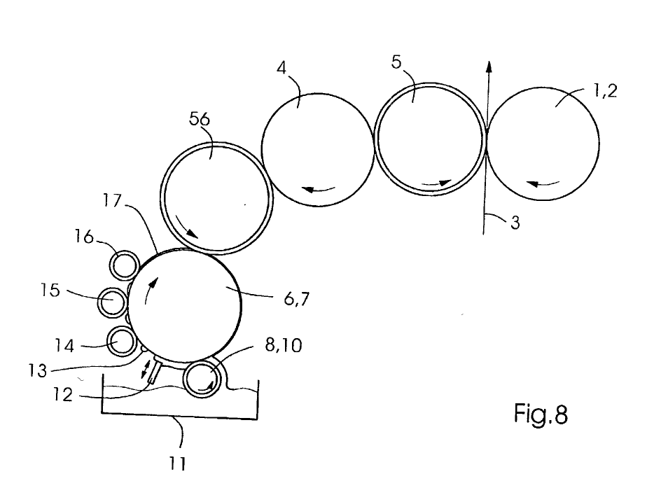

In FIG. 8, a modified roller configuration is presented which differs from that of FIG. 1 only in that the roller 7, whereon the ink pattern 13 is produced, does not roll on the printing form cylinder 4 but on a roller 56 formed as a form roller, which then rolls on the printing form cylinder 4. Consequently, the roller 56, the diameter of which corresponds to those of the roller 7 and of the printing form cylinder 4, has a rubber-elastic and elastomeric peripheral or outer cylindrical surface, respectively. The printing form cylinder 4 and the roller 56 rotate angle-synchronously with one another at the same rotational speed as they roll on one another.

The roller 7 preferably has a smooth or, if necessary or desirable, also with a cell-grid or screen, hard and, for example, a ceramic peripheral surface. The rollers 10, 14, 15, 16 have rubber-elastic and elastomeric peripheral surfaces, respectively.

It is believed to be readily apparent that also with the roller configuration illustrated in FIG. 8, instead of using the ink-feeding device 8, the ink-feeding device 48 of the embodiment of FIG. 7 can be used, and instead of the ink-metering device 12, also the ink-metering device 47 of the embodiment of FIG. 7 can be used with the roller configuration of FIG. 8.

I claim:

1. An inking unit in a printing press, comprising an ink-metering device having at least one metering element operatively engaging with a roller, said roller being one of an ink form roller and a roller operatively engaging with an ink form roller, and an oscillation device assigned to said metering element for mounting said metering element so that it is oscillatable between a feeding position and a spaced-away position of the metering element.

2. The inking unit according to claim 1, wherein said oscillation device has a guide for guiding said metering element in an at least approximately radial oscillation direction relative to said roller.

3. The inking unit according to claim 1, wherein said oscillation device has an electromagnetic oscillation drive drivingly connected to said metering element.

4. The inking unit according to claim 1, wherein said oscillation device has a spring for setting said metering element against said roller.

5. The inking unit according to claim 1, wherein said metering element is a metering blade having a working region terminating in a cutting edge, said working region of said metering blade having a cross-section thickness which remains constant.

6. The inking unit according to claim 1, including at least one glazed roller disposed downline from said metering element along a peripheral line of said first-mentioned roller, said glazed roller being exclusively in rolling contact with said first-mentioned roller.

7. The inking-unit according to claim 1, including an ink-feeding device disposed upline of said metering element alongside a peripheral line of said first-mentioned roller.

8. The inking unit according to claim 1, including at least another metering element assigned to said first-mentioned roller.

9. The inking unit according to claim 8, wherein said metering elements are mounted alternatingly with one another for removal thereof from said first-mentioned roller.

10. A printing press having an inking unit comprising an ink-metering device having at least one metering element operatively engaging with a roller, said roller being one of an ink form roller and a roller operatively engaging with an ink form roller, and an oscillation device assigned to said metering element for mounting said metering element so that it is oscillatable between a feeding position and a spaced-away position of the metering element.
